(19) United States
(12) Patent Application Publication
(10) Pub. No.: US 2026/0102727 A1
(43) Pub. Date: Apr. 16, 2026

(54) FAN FILTER UNIT AND CONTROL METHOD THEREOF

(71) Applicant: United Microelectronics Corp., Hsinchu (TW)

(72) Inventors: Chin-Hsin CHIU, Tainan City (TW); Jui-Hung Lee, Kaohsiung City (TW); Chia-Jung Chang, Tainan City (TW); Hung-Min Juang, Tainan City (TW)

(21) Appl. No.: 18/938,348

(22) Filed: Nov. 6, 2024

(30) Foreign Application Priority Data
Oct. 14, 2024 (TW) 113138973

(51) Int. Cl. B01D 46/46; B01D 46/00; B01D 46/42; F04D 25/06; F04D 27/00; F04D 29/70

(52) U.S. Cl. CPC B01D 46/46; B01D 46/0041; B01D 46/0086; B01D 46/0095; B01D 46/4245; B01D 46/429; F04D 25/0673; F04D 27/008; F04D 29/703; B01D 2279/51

(57) ABSTRACT

A fan filter unit and a control method thereof are provided. The fan filter unit includes a fan and a control module. The control module includes a logic judgment circuit, a fan power supply and a control circuit. The logic judgment circuit is connected to an apparatus power supply of a semiconductor apparatus. The logic judgment circuit is used to judge whether the apparatus power supply is shut down. The control circuit is connected to the fan power supply and the logic judgment circuit. If the apparatus power supply is shut down, the control circuit switches a fan power supply path from the apparatus power supply to the fan power supply.

This application claims the benefit of Taiwan application Serial No. 113138973, filed Oct. 14, 2024, the disclosure of which is incorporated by reference herein in its entirety.

### TECHNICAL FIELD

The disclosure relates in general to an equipment and a control method, and more particularly to a fan filter unit and a control method thereof.

### BACKGROUND

In the semiconductor clean room and the wafer transfer space, the cleanliness must be maintained at a very high level to prevent particles from staying on the wafer and causing damage to semiconductor components. In order to take particles away smoothly, a fan filter unit is used to create airflow. However, when the semiconductor equipment is shut down or restarted in an emergency, the fan filter unit will also stop, so particles may stay on the wafer, causing damage to the semiconductor components.

### SUMMARY

The disclosure is directed to a fan filter unit and a control method thereof. A control module is used to switch a fan power supply path of the fan filter unit so that the fan filter unit can keep running and avoid particles that may stay on the wafer and cause damage to semiconductor components.

According to one embodiment, a fan filter unit (FFU) is provided. The fan filter unit includes a fan and a control module. The control module includes a logic judgment circuit, a fan power supply and a control circuit. The logic judgment circuit is connected to an apparatus power supply of a semiconductor apparatus. The logic judgment circuit is used to detect whether the apparatus power supply is shut down. The control circuit is connected to the fan power supply and the logic judgment circuit. If the apparatus power supply is shut down, the control circuit switches a fan power supply path from the apparatus power supply to the fan power supply.

According to another embodiment, a control method of a fan filter unit is provided. The control method of the fan filter unit includes: detecting, by a logic judgment circuit, whether an apparatus power supply is shut down; and switching, by a control circuit, a fan power supply path from the apparatus power supply to a fan power supply if the apparatus power supply is shut down.

According to an alternative embodiment, a control module of a fan filter unit is connected to a fan. The control module includes a logic judgment circuit, a fan power supply and a control circuit. The logic judgment circuit is connected to an apparatus power supply of a semiconductor apparatus. The logic judgment circuit is configured to detect whether the apparatus power supply is shut down. The control circuit is connected to the fan power supply and the logic judgment circuit. If the apparatus power supply is shut down, the control circuit switches a fan power supply path from the apparatus power supply to the fan power supply.

### BRIEF DESCRIPTION OF THE DRAWINGS

FIG. 1A is a schematic diagram of the operation of a fan filter unit according to an embodiment of the present disclosure.

FIG. 1B illustrates an operation diagram of the fan filter unit according to another embodiment of the present disclosure.

FIG. 2 illustrates a block diagram of a fan filter unit according to an embodiment of the present disclosure.

FIG. 3 illustrates a flow chart of a control method of the fan filter unit according to an embodiment of the present disclosure.

FIG. 4 illustrates a flow chart of a control method of the fan filter unit according to another embodiment of the present disclosure.

FIG. 5 illustrates a flow chart of a control method of the fan filter unit according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

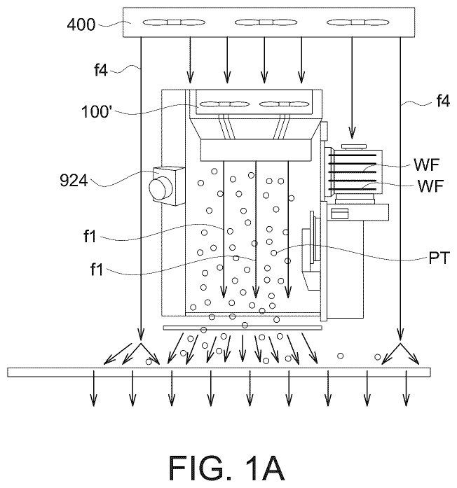

Please refer to FIG. 1A, which is a schematic diagram of the operation of a fan filter unit 100′ according to an embodiment of the present disclosure. In the semiconductor manufacturing process, the clean room needs to use a blower 400 to continuously blow out an airflow f4 to take away particles PT in the air and prevent the particles PT from staying on the wafer WF.

In addition, when transferring the wafer WF into the semiconductor apparatus (such as etching machine, deposition machine, and measurement apparatus), it is also necessary to use the fan filter unit 100′ to continuously create the airflow f1 to take away the particles PT in the air, and avoid particles PT staying on the wafer WF.

Please refer to FIG. 1B, which illustrates an operation diagram of the fan filter unit 100′ according to another embodiment of the present disclosure. In the embodiment of FIG. 1B, only the apparatus power supply of the semiconductor apparatus is provided to the fan filter unit 100. Therefore, when the apparatus emergency power off switch 924 of the semiconductor apparatus is pushed, the power supply to the fan filter unit 100′ will be cut off and the fan filter unit 100 will stop operating. At this time, without the airflow f1, the particles PT will easily stay on the surface of the wafer WF, thus affecting subsequent processes.

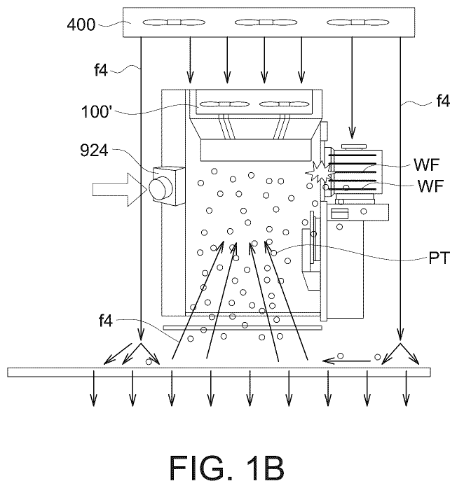

Please refer to FIG. 2, which illustrates a block diagram of a fan filter unit 100 according to an embodiment of the present disclosure. The fan filter unit 100 includes a fan 110 and a control module 120. The control module 120 includes a logic judgment circuit 121, a fan power supply 122, a control circuit 123, a fan emergency power off switch 124, a detection circuit 125 and a communication circuit 126.

The logic judgment circuit 121 is connected to an apparatus power supply 922 of the semiconductor apparatus 900, the control circuit 123, a ground end 800, and the fan emergency power off switch 124. The control circuit 123 is connected to the fan power supply 122 and the logic judgment circuit 121. The logic judgment circuit 121, the control circuit 123 and the detection circuit 125 are used to perform various judgment, control, analysis, detection and data collection procedures. The logic judgment circuit 121, the control circuit 123 and/or the detection circuit 125 is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

In this embodiment, the control module 120 switches the fan power supply path PH1 of the fan filter unit 100 so that the fan filter unit 100 can keep running and avoid particles PT from staying on the wafer WF, causing damage to semiconductor components. The following is a flow chart to illustrate the operation of each component.

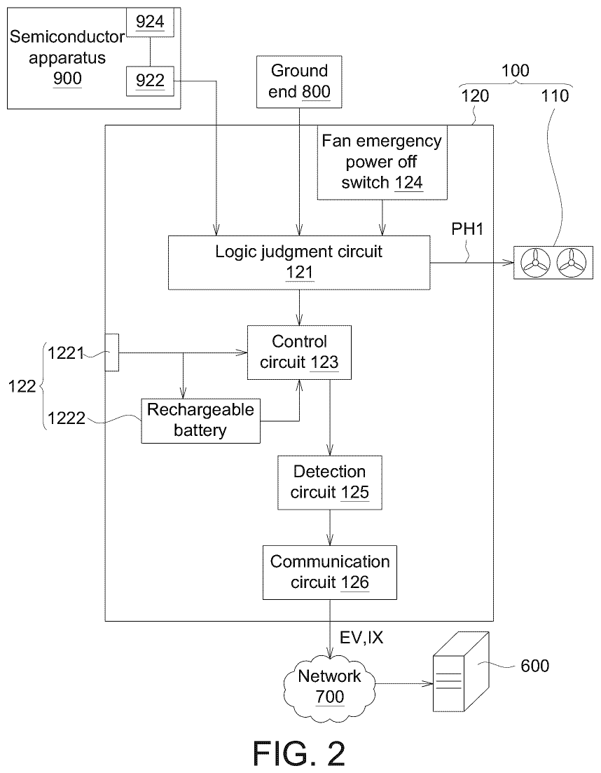

Please refer to FIGS. 2 and 3 at the same time. FIG. 3 illustrates a flow chart of a control method of the fan filter unit 100 according to an embodiment of the present disclosure. The control method of the fan filter unit 100 includes step S110 to step S120. In step S110, as shown in FIG. 2, the logic judgment circuit 121 determines whether the apparatus power supply 922 is shut down. The reason for shutting down the apparatus power supply 922 is, for example, that the semiconductor apparatus 900 has an abnormality and needs to be turned off; or an emergency occurs in the semiconductor apparatus 900, and the operator presses the apparatus emergency power off switch 924 to forcibly power off the semiconductor apparatus 900; or the semiconductor apparatus 900 needs to be turned off for maintenance. If the apparatus power supply 922 is shut down, the process proceeds to the step S120.

In the step S120, as shown in FIG. 2, the control circuit 123 switches the fan power supply path PH1 of the fan 110 from the apparent power supply 922 to the fan power supply 122. The fan power supply 122 includes an AC power port 1221 and a rechargeable battery 1222. The rechargeable battery 1222 of the fan power supply 122 could provide 24V power to allow the fan 110 to continue to operate normally.

According to the above control method, when the operator presses the apparatus emergency power off switch 924 on the semiconductor apparatus 900, it will not cause a power outage of the fan filter unit 100, and the normal operation of the fan filter unit 100 can be maintained.

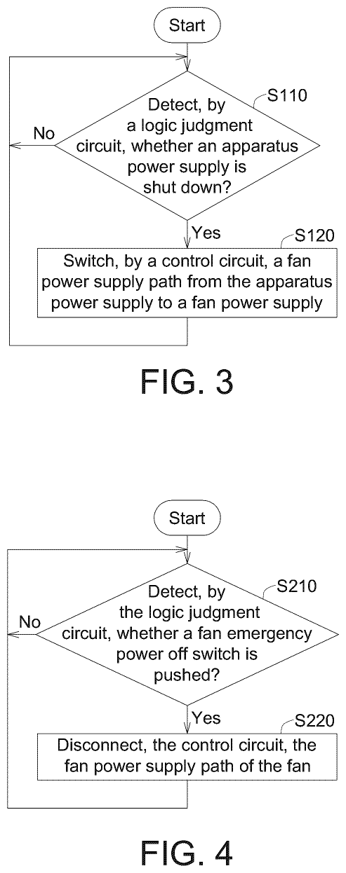

Please refer to FIG. 2 and FIG. 4. FIG. 4 illustrates a flow chart of a control method of the fan filter unit 100 according to another embodiment of the present disclosure. The control method of the fan filter unit 100 further includes step S210 to step S220. In the step S210, as shown in FIG. 2, the logic judgment circuit 121 determines whether the fan emergency power off switch 124 is pushed.

The fan emergency power off switch 124 is disposed on (or is electrically connected to) the fan filter unit 100, and the apparatus emergency power off switch 924 is disposed on (or is electrically connected to) the semiconductor apparatus 900. The fan emergency power off switch 124 is different from the apparatus emergency power off switch 924. If the fan emergency power off switch 124 is pushed, the process proceeds to the step S220.

Then, in the step S220, as shown in the FIG. 2, the control circuit 123 disconnects the fan power supply path PH1 of the fan 110. In other words, regardless of whether the semiconductor apparatus 900 is shut down, the fan power supply path PH1 of the fan 110 can be switched between the apparent power supply 922 and the fan power supply 122. Only when the fan emergency power off switch 124 is pushed, the fan power supply path PH1 of the fan 110 will be disconnected.

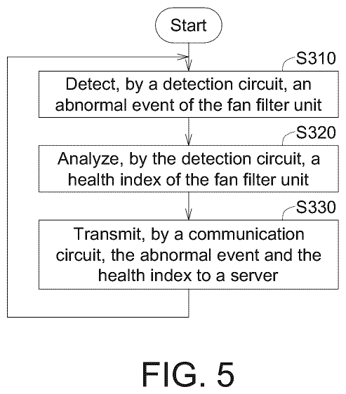

Please refer to FIG. 2 and FIG. 5. FIG. 5 illustrates a flow chart of a control method of the fan filter unit 100 according to another embodiment of the present disclosure. The control method of the fan filter unit 100 further includes step S310 to step S330.

In the step S310, as shown in the FIG. 2, the abnormal event EV of the fan filter unit 100 is detected by the detection circuit 125. The abnormal event EV is, for example, short, excessive temperature, stuck by foreign objects, or excessive noise.

Then, in the step S320, as shown in FIG. 2, a health index IX of the fan filter unit 100 is analyzed by the detection circuit 125. For example, the detection circuit 125 uses a prediction model to predict the health index IX according to the above abnormal event EV records. The health index IX represents the health status of the fan filter unit 100. When the health index IX is lower than a predetermined level, the fan filter unit 100 needs to be inspected, maintained or replaced.

Then, in the step S330, as shown in FIG. 2, the abnormal event EV and the health index IX are transmitted to a server 600 through the communication circuit 126. The abnormal event EV and the health index IX will be transmitted to the server 600 via the network 700 for subsequent statistics and analysis.

Through the above embodiment, the control module 120 switches the fan power supply path PH1 of the fan filter unit 100, so that the fan filter unit 100 can keep running and avoid particles PT from staying on the wafer WF and causing damage to the semiconductor components.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A fan filter unit (FFU), comprising:
a fan; and
a control module, including:
a logic judgment circuit, connected to an apparatus power supply of a semiconductor apparatus, wherein the logic judgment circuit is used to detect whether the apparatus power supply is shut down;
a fan power supply; and
a control circuit, connected to the fan power supply and the logic judgment circuit, wherein if the apparatus power supply is shut down, the control circuit switches a fan power supply path from the apparatus power supply to the fan power supply.

2. The fan filter unit according to claim 1, wherein the control module further comprises:
a fan emergency power off switch, wherein the logic judgment circuit detects whether the fan emergency power off switch is pushed, if the fan emergency power off switch is pushed, the control circuit disconnects the fan power supply path of the fan.

3. The fan filter unit according to claim 2, wherein the fan emergency power off switch is disposed on the fan filter unit, an apparatus emergency power off switch is disposed on the semiconductor apparatus, and the fan emergency power off switch is different from the apparatus emergency power off switch.

4. The fan filter unit according to claim 1, wherein the logic judgment circuit is further connected to a ground end.

5. The fan filter unit according to claim 1, wherein the control module further comprises:
a detection circuit, configured to detect an abnormal event of the fan filter unit, and analyze a health index of the fan filter unit; and
a communication circuit, configured to transmit the abnormal event and the health index to a server.

6. The fan filter unit according to claim 1, wherein the fan power supply includes an AC power port and a rechargeable battery.

7. The fan filter unit according to claim 6, wherein the fan power supply provides 24V power, the apparatus power supply provides 24V power.

8. A control method of a fan filter unit, comprising:
detecting, by a logic judgment circuit, whether an apparatus power supply is shut down; and
switching, by a control circuit, a fan power supply path from the apparatus power supply to a fan power supply if the apparatus power supply is shut down.

9. The control method of the fan filter unit according to claim 8, further comprising:
detecting, by the logic judgment circuit, whether a fan emergency power off switch is pushed; and
disconnecting, the control circuit, the fan power supply path of the fan if the fan emergency power off switch is pushed.

10. The control method of the fan filter unit according to claim 9, wherein the fan emergency power off switch is disposed on the fan filter unit, an apparatus emergency power off switch is disposed on the semiconductor apparatus, and the fan emergency power off switch is different from the apparatus emergency power off switch.

11. The control method of the fan filter unit according to claim 8, further comprising:
detecting, by a detection circuit, an abnormal event of the fan filter unit;
analyzing, by the detection circuit, a health index of the fan filter unit; and
transmitting, by a communication circuit, the abnormal event and the health index to a server.

12. The control method of the fan filter unit according to claim 8, wherein the logic judgment circuit is further connected to a ground end.

13. The control method of the fan filter unit according to claim 8, wherein the fan power supply includes an AC power port and a rechargeable battery.

14. A control module of a fan filter unit, connected to a fan, wherein the control module comprises:
a logic judgment circuit, connected to an apparatus power supply of a semiconductor apparatus, wherein the logic judgment circuit is configured to detect whether the apparatus power supply is shut down;
a fan power supply; and
a control circuit, connected to the fan power supply and the logic judgment circuit, wherein if the apparatus power supply is shut down, the control circuit switches a fan power supply path from the apparatus power supply to the fan power supply.

15. The control module according to claim 14, further comprising:
a fan emergency power off switch, wherein the logic judgment circuit detects whether the fan emergency power off switch is pushed, if the fan emergency power off switch is pushed, the control circuit disconnects the fan power supply path of the fan.

16. The control module according to claim 15, wherein the fan emergency power off switch is disposed on the fan filter unit, an apparatus emergency power off switch is disposed on the semiconductor apparatus, and the fan emergency power off switch is different from the apparatus emergency power off switch.

17. The control module according to claim 13, wherein the logic judgment circuit is further connected to a ground end.

18. The control module according to claim 13, further comprising:
a detection circuit, configured to detect an abnormal event of the fan filter unit, and analyze a health index of the fan filter unit; and
a communication circuit, configured to transmit the abnormal event and the health index to a server.

19. The control module according to claim 14, wherein the fan power supply includes an AC power port and a rechargeable battery.

20. The control module according to claim 19, wherein the fan power supply provides 24V power, the apparatus power supply provides 24V power.
